(19) United States
(12) Patent Application Publication
(10) Pub. No.: US 2006/0064602 A1
(43) Pub. Date: Mar. 23, 2006

(54) Navigating to content in a recording

(76) Inventor: Frank Uittenbogaard, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,985

(22) PCT Filed: Dec. 4, 2003
(86) PCT No.: PCT/IB03/05921

§ 371 Date: Jul. 11, 2005

(30) Foreign Application Priority Data
Jan. 13, 2003 (EP) 03075081.4

(51) Int. Cl. G06F 12/14

(52) U.S. Cl. 713/193

(57) ABSTRACT

The method according to the invention enables a user to navigate to a desired part (310) in a recording (302). The recording (302) is created from a received signal (110), whereby a plurality of positions in the recording are associated with respective points in time (316) from which the signal representing content at these positions has been received. The user specifies a desired point in time (320), from which the signal representing the desired part is known to have been received. Subsequently, playback of the recording is proceeded at the particular position (322) in the recording of which the associated point in time substantially equals the desired point in time, whereby verification whether the associated point in time substantially equals the desired point in time is executed by a device.

The invention relates to a method of enabling a user to navigate to a desired part in a recording.

The invention further relates to a reproduction device enabling a user to navigate to a desired part in a recording.

The invention further relates to a computer program product containing code for causing a processor to enable a user to navigate to a desired part in a recording.

European Patent Application published under number 1 102 282 A1, describes a system for helping a user to find a desired program from a collection of recorded television programs. The known system stores the recorded television programs on a storage medium, which may be a hard disk device. In addition to the program data itself, the system stores for each recorded program a number of attributes, including the date and time of recording. The system maintains an index table in which the attributes of a program are linked to the location of the program itself on the storage medium. A user may remember the date and time at which a certain television program has been broadcast and recorded. Through consultation of the table, the desired program is found on the storage medium and played back.

It is an object of the invention to provide a method as described in the preamble that can locate recorded content in an improved way. This object is achieved according to the invention in such a method comprising:
creating the recording from a received signal,
associating a plurality of positions in the recording with respective points in time from which the signal representing content at these positions has been received,
obtaining a desired point in time, from which the signal representing the desired part is known to have been received, and
proceeding to the particular position in the recording of which the associated point in time substantially equals the desired point in time, whereby verification whether the associated point in time substantially equals the desired point in time is executed by a device.

This method allows the user to easily jump to a certain part inside a recording when he knows the point in time at which this part was received to be recorded. The user simply specifies this point in time, expressed as the original time of receiving and recording that part, and a jump is made to the particular position in the recording corresponding with this part. This provides for a finer granularity for navigating in recorded content than according to the known method, which is only able to find recordings as a whole. The method according to the invention is able to navigate inside a recording. This can advantageously be used when a recording contains distinguishable parts each having their own time of receiving the signal representing that part. An example of this is a television recording covering a number of programs or a recording of a program with a number of program fragments each with their own known broadcast time.

An embodiment of the method according to the invention is described in claim 2. Assigning the recording as a whole an overall time of recording and the positions in the recording with indications of progress of time inside the recording is an easy mechanism for determining the time of recording of each of the positions. When the recording is played back, the overall recording time is used as some kind of offset for the time indications associated with the positions. In a simple realization of this embodiment, the position timestamps are emulated by a simple timer. At playback, the timer keeps track of the time passed since the begin of the recording.

An embodiment of the method according to the invention is described in claim 4. The invention can advantageously be used for the recording of broadcast programs, like television programs. A user will often be familiar with the scheduled broadcast times of such programs. In this embodiment, these broadcast times are used to locate programs in a recording.

An embodiment of the method according to the invention is described in claim 5. If it is established that the actual time of receiving and recording the program is different from the scheduled broadcast time, then this established difference might be used for navigating to the desired content. This difference may be established from an Electronic Program Guide indicating the scheduled and the actual broadcast time.

It is a further object of the invention to provide a reproduction device as described in the preamble that can locate recorded content in an improved way. This object is achieved in a reproduction device wherein a plurality of positions in the recording are associated with respective points in time from which the signal representing content at these positions has been received, the device comprising:
verification means for verifying whether the associated point in time of a particular one of the plurality of positions in the recording substantially equals a desired point in time from which the signal representing the desired part is known to have been received, and
proceeding means for proceeding to the particular one of the plurality of positions in the recording of which the associated point in time substantially equals the desired point in time.

Using this device, the user can navigate to the desired part if the recording on the basis of the time of receiving and recording that part.

The invention and its attendant advantages will be further elucidated with the aid of exemplary embodiments and the accompanying schematic drawings, wherein:

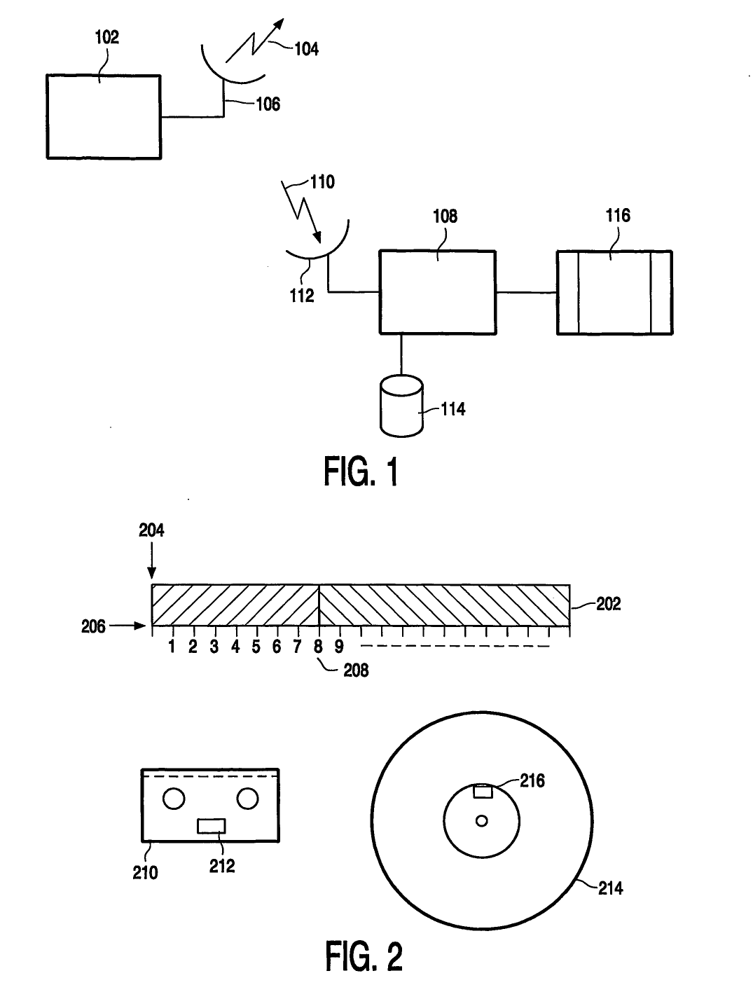

FIG. 1 schematically shows an environment in which the invention is used,

FIG. 2 schematically shows a recording according to the invention,

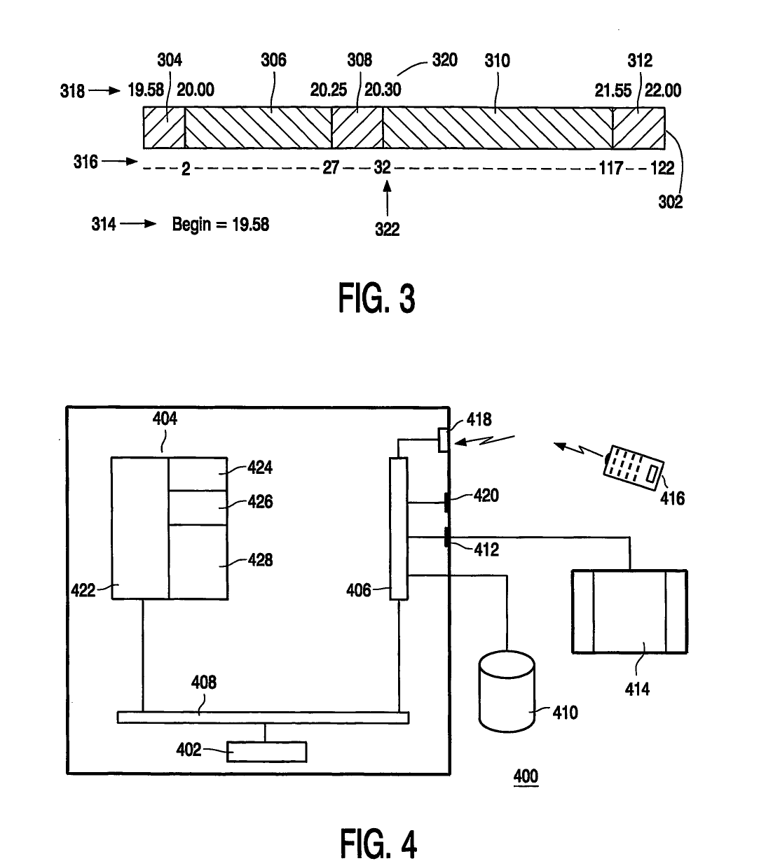

FIG. 3 shows an example recording in which the user can navigate according to the invention, and

FIG. 4 schematically shows a reproduction device according to the invention.

Corresponding features in the various Figures are denoted by the same reference symbols.

FIG. 1 schematically shows an environment in which the invention is used. A broadcaster 102 broadcasts a signal 104, representing a number of television programs, through a transmitting antenna 106. Typically, the signal is sent to a satellite that broadcasts the received signal back to earth for reception at many sites. At the site of the user, a video recorder 108 is capable of receiving a signal 110 representing the programs through an antenna 112. The video recorder selectively receives programs from the signal and records these selected programs on a local storage medium. Instead of receiving the signal through an antenna, the signal may be provided to the user via a network provider and received by the video recorder 108 through a cable connection. Other alternatives for receiving the signal are also possible. Furthermore, the programs may be provided to the video recorder of the user in a completely different way than through broadcasting, e.g. through a removable storage medium. The video recorder has a local storage medium, like hard disk 114, for storing recordings. Alternatives to the hard disk are videotape in a cassette and optical disk. The video recorder is later used as a reproduction device for play back of a recording on a display 116.

FIG. 2 schematically shows a recording according to the invention. A recording is an amount of recorded content that is handled by the user as a single entity. On a tape a recording is typically an amount of audio and/or video that has been recorded without interrupts from a specific start time to a specific end time. The same is true for a recording on a disk and there a recording is typically stored as a single file. One recording may contain more than one program, e.g. two successive television programs and the commercial break in between may have been recorded in one go. The recording 202 has a begin timestamp 204. This begin timestamp 204 indicates the point in time at which the recording process of received signal has started. This timestamp is expressed in relation to the real date and time from which the signal representing the program has been received. In the case of application of the invention in a broadcast environment described above, the begin timestamp is the point in time from which the signal 110 is has been received. Usually, the begin timestamp will be the same as the point in time where the recording itself has been created, i.e. when the file on disk or tape has been created. However, in the case that a recording is copied than the begin timestamp of the copy will still be the point in time of the original recording and will not be the point in time that the copy is created. The recording 202 contains a series of position timestamps 204 indicating the point in time of reception and recording of the signal at the respective positions. Thus, a certain position timestamp in the recording indicates the point in time from which the content recorded at the corresponding position has been received and recorded. For example in the case of recording a broadcast program, the position timestamp equals the broadcast time of the recorded content. In one embodiment, a position timestamp is expressed with reference to the begin timestamp. The position timestamp then indicates the time lapsed since the beginning of the recording. For example, position timestamp 208 indicates that 8 time units have passed since the beginning of the recording. In terms of recording the signal representing the program, timestamp 208 indicates that the content at the position corresponding with that timestamp has been received and recorded at the point in time that equals the begin timestamp plus 8 time units. The size of a time unit may be chosen depending on the need of precision of the application at hand. It may be chosen as 1 minute, 1 second or any other suitable period. The invention allows the user to navigate to a particular piece of content in the recording on the basis of the point in time where the signal of that piece has been received and recorded. Particularly when using the invention in a broadcast environment, the user may easily remember the time of broadcasting and recording of the desired part of a recording, as will be further explained below with connection to FIG. 3.

The recording may be made with a VCR (VideoCassette Recorder) on a videocassette 210. The position timestamps are then recorded on the tape of the cassette in a track that is additional to the data representing the audio and video itself. These timestamps may be realized as pulses added at equidistant moments on the tape, e.g. every second a pulse is written to the track on the tape. When the tape is played back, the pulses are counted relative to the beginning of the recording and in this way the time since the beginning of the recording can be obtained for the positions on the tape. And thus, the point in time at which the signal recorded at that position has been received and recorded can be determined. Instead of simply writing pulses to the track, a time indicator may be written to the track indicating the time lapsed since the beginning of the recording. Then it is not necessary to always start counting at the beginning but the time indicator on an arbitrary piece of tape may be read and it can then immediately be determined how much time this piece is after the begin of the recording. The begin timestamp may be recorded embedded in the recording or at a dedicated position, e.g. at the beginning of a recording. Alternatively, the begin timestamps of various recordings on the tape may be recorded on a dedicated position on the tape, e.g. as a piece of coded data at the beginning of the tape. In an other alternative, the begin timestamp may be stored in a memory device 212 attached to the housing of the tape. This so-called chip-on-cassette may be read by the video recorder 108 when the cassette is in the recorder. The memory device may be used to store the begin timestamps of the recordings on the tape and may be used to store further data. Rather than expressing the time relative to the beginning, in a still further alternative the position timestamps are directly expressed as the points in time of receipt and recording of the signal representing the recorded program. In this embodiment, a begin timestamp is not required since the position timestamps themselves express the time of receipt and recording the signal at the corresponding position. In a still further alternative, the position timestamps are coupled to the transport mechanism of the tape. A unit of time between timestamps corresponds with a certain length of tape. When a position on the tape must on the basis of a given timestamp, it can be calculated how much tape must be transported to reach that position. And vice versa, when a certain length of tape has passed it can be calculated how much time has progressed in the recording.

Alternative to a videocassette, an optical disk 214 may be used to store the recording. In this case the video content is stored as a file on the disk in a compressed form in the MPEG format. This format allows for timestamps indicating the progression of time of the video data from the file. When playing back, these timestamps may be supplied by the MPEG decoder and used for navigating. Furthermore, a table may be used that indexes the video data on the basis of time. An example of such a table is given below.

| Time | Position in file |
|---|---|
| 0010 | 0000120 |
| 0020 | 0000240 |
| . | . |
| . | . |
| . | . |
| 0120 | 0001150 |
| . | . |
| . | . |
| . | . |

Through this table, it is possible to jump to a position in the file on the basis of a certain time passed since the beginning of the recording. Thus such a table may be used as position timestamps to navigate through the recording. The begin timestamp indicating the beginning of receipt and recording of the signal representing the program can be stored as an attribute of the file. An example is the attribute Information Time Existence, specified in Part 4, paragraph 14.10.6 of the Standard ECMA-167, called “Volume and File Structure for Write-Once and Rewritable Media using Non-Sequential Recording for Information Interchange. This attribute can be used to specify “the date and time of the day at which the information in the file was created.” Alternatively, the begin timestamps of the recordings on a disk may be stored in a memory device attached to the disk itself. This so-called chip on disk is read by the recorder when the disk is in the recorded.

In a still further embodiment, the video recorder may use a hard disk rather than an optical disk for storing the video and the timestamps. In this case, the video is also compressed according to MPEG and stored in a file. The position timestamps may be created in the same way as described above. The begin timestamp may by created as an attribute of the file or as may be stored in a separate file. This separate file may contain the begin timestamps of other recordings on the disk and may contain further data about the recordings. If the position timestamps are created as the actual points in time of receiving and storing the signal representing the program, then the begin timestamp is not necessary.

FIG. 3 shows an example recording in which the user can navigate according to the invention. The recording 302 contains a number of parts which have been broadcast successively and which have been recorded without pausing the recording process. In the example, the user has programmed the video recorder to record the broadcast signal from 19.58 until 22.00 hours. In the example, the user has made the recording because he was interested in the news program from 20.00 until 20.25 hours and in the TV movie from 20.30 until 21.55. Part 304 is a part containing the last few minutes of the television program prior to the news. The user has programmed the video recorder to start a little earlier than the scheduled begin time of the news as a safety margin. The content in part 304 is of no interest to the user. Part 306 is the news that has been broadcast from 20.00 until 20.25. Part 308 is the break between the news and the TV movie starting at 20.30. This break contains advertisements and other announcements. Part 310 contains the movie that has been broadcast from 20.30 until 21.55. Part 312 has been recorded because the user has, as a safety margin, programmed the recorder to record a little beyond the point in time where the TV movie is expected to end. The recording 302 has a begin timestamp 314 which has a value of 19.58 indicating that recording of the broadcast signal has started at 19.58 hours. The recording 302 further contains a number of position timestamps 316 indicating the time at which recording the corresponding parts has started. The position timestamps are expressed in minutes passed since the beginning of the recording. The times 318 at which the recording of the various parts has been started are obtained on the basis of the begin timestamp and the respective position timestamps. Therefore, the times 318 need not be stored with the recording.

The user can navigate through the recording 302 on the basis of the times at which the broadcast parts have been received and recorded. For example, if the user is watching the end of the news and then wants to start watching the TV movie, i.e. part 310, he wants to instruct the video record to jump to or move to the beginning of that part. The user will remember that the TV movie was originally broadcast and recorded at 20.30 and he will instruct the video recorder to move or jump to the position that corresponds with the timestamp 20.30. Thus in this example, the desired point in time 320 has the value ‘20.30’ and the corresponding position 322 is at the beginning of part 310. In a very simple embodiment, the video recorder will display the times 318 of recording and the user can enter the command fast forward and monitor the displayed time. The times 318 are displayed on a display device on the video recorder, which display device may at other moments be used for other purposes like for entering the start time and stop time when programming the video recorder for making a recording. When the displayed time has reached 20.30, the user interrupts the fast forward command and enters the play command. Entering the above commands is typically done with dedicated buttons on the remote control of the video recorder. Alternatively, buttons on the video recorder itself may be used. In another embodiment, the user enters the time 20.30 followed by the command to jump to the position corresponding with that time. Especially if the recording is made on a hard disk with an index table, the video recorder can quickly jump to that position without having to process the intermediate video data.

In the example of FIG. 3, the timestamps relate to the times at which the corresponding signals have been broadcast. This will usually be the scheduled broadcast time as advertised in the television guide. Such a guide may be in the form of a printed magazine with an overview of the programs for the available channels. However, a television guide may also be provided in electronic form. Such an Electronic Program Guide may be transmitted as data together with one of the program or may be transmitted in a dedicated channel. The actual broadcast of a program may be different from the scheduled broadcast time. For example, the start of the broadcast of the TV movie in part 310 may be at 20.33 instead of the scheduled 20.30. This delay may be obtained by the video recorder and recorded as an offset for the relevant program. One way of obtaining the delay is by means of the Teletekst service. In this service, the scheduled broadcast and the revised broadcast time are provided as data to the video recorder that can determine the offset. Another way of providing the delay is through the Electronic Program Guide. Also in this service, the scheduled broadcast time and the revised broadcast time may be supplied. In an embodiment of the invention, the offset is used to correct for the difference between scheduled and actual broadcast time when the user navigates through the recording. In this embodiment, the user in the above example still specifies that he wants to start watching a program that should have been recorded at 20.30. Because of the delay, the position timestamp of that program will be 35, instead of the 32 in FIG. 3. However, the invention corrects this timestamp with the offset of 3 and together with the begin timestamp determines the correct position in the recording. As an alternative to correcting the position timestamp afterwards, i.e. when navigating, the timestamps may be corrected during the recording process. In this alternative, the timestamps relate to the scheduled time of recording and no longer to the actual time of recording.

FIG. 4 schematically shows a reproduction device according to the invention. The reproduction device 400 is constructed on the basis of a general-purpose computer with a know architecture. The reproduction device 400 has a processor 402 for executing program instruction of a program containing program units loaded in a working memory 404. The reproduction device 400 has an interface 406 for communication with external peripherals. Furthermore, the reproduction device has a bus 408 for exchanging commands and data between the various components of the device; The reproduction device further has a storage medium 410 for storing the recordings and other data as described above. Also the program units that are loaded into the working memory in operation are stored on the storage medium. The storage medium is a magnetic hard disk, but other suitable types of storage medium can be used, e.g. an optical disk. The storage medium may be located inside the housing 411 of the reproduction device 400 or may be placed externally and connected to the interface 406. Furthermore, the reproduction device has an output connection 412 for connecting to an external display device 414 for reproducing a recording. This display device 414 is typically a traditional television set. The reproduction device 400 has a remote control 416 to allow a user to control the device. The user can enter commands and data by means of buttons on the remote control 416. The remote control 416 transmits corresponding infrared signals that are received by an infrared receiver 418 in the housing of the reproduction device. The reproduction device 400 optionally has a signal connection 420 through which signals representing programs to be recorded can be received. In this embodiment, the reproduction device is able to create a recording as described above.

The functionality of the reproduction device 400 is implemented by the program units that are loaded into the working memory. The distribution of functions over the various program units in the embodiment shown in FIG. 3 is described below. This is by way of example only, and other distributions realizing the same overall functionality of the reproduction device are possible. The reproduction device has software for control and various traditional functions for the playback of a recording, like ‘play’, ‘pause’, ‘stop’ and the like. This software is symbolized by software unit 422 and is not further detailed in the present document, since this software per se is known and the detail is not required for explaining the present invention. There is a verification unit 424 for verifying whether the associated point in time of a particular position in the recording equals the desired point in time from which the signal representing the part of the recording desired by the user has been received. The user specifies the point in time from which the signal is known to have been received. The verification unit 424 compares this desired point in time with the position timestamps provided along the recording. Furthermore, there is a proceeding unit 426 for proceeding the recording to the position that corresponds with the desired point in time. In the present embodiment where the recording is stored as a file on a hard disk, the proceeding unit determines this position on the basis of an index table as described above. In an embodiment where the recording is stored on a tape, the proceedings unit needs to wind the tape to the required position while monitoring the timestamps along the recording.

The reproduction device optionally includes an offset obtaining unit 428 for obtaining an offset indicating the difference between the scheduled broadcast time and the actual point in time from which the broadcast signal representing the desired part has been received. The offset may be retrieved from an Electronic Program Guide, for which the data are received through signal connection 420. In this embodiment, the verification unit is arranged to verify whether the associated point in time equals the desired point in time on basis of the offset. In a further embodiment, the reproduction device is able to determine on the basis of the Electronic Program Guide the list of programs inside a recording if such a recording contains multiple programs. This list may be presented to the user. If the user selects one of the programs, the device directly proceeds to that program. The reproduction device determines the position to proceed to on the basis of the broadcast time, corrected with the offset if necessary.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

1. A method of enabling a user to navigate to a desired part in a recording, comprising:
creating the recording from a received signal,
associating a plurality of positions in the recording with respective points in time from which the signal representing content at these positions has been received,
obtaining a desired point in time, from which the signal representing the desired part is known to have been received, and
proceeding to the particular position in the recording of which the associated point in time substantially equals the desired point in time, whereby verification whether the associated point in time substantially equals the desired point in time is executed by a device.

2. A method as claimed in claim 1, whereby associating the plurality of positions in the recording with respective points in time is realized by:
assigning to the recording a begin timestamp indicating the point in time from which the signal representing the begin of the recording has been received, and
assigning to each of the plurality of positions in the recording a position timestamp indicating, relative to the begin timestamp, the point in time from which the signal representing content at that position has been received.

3. A method as claimed in claim 1, whereby associating the plurality of positions in the recording with respective points in time is realized by assigning to each of the plurality of positions in the recording a position timestamp indicating the point in time from which the signal representing content at that position has been received.

4. A method as claimed in claim 1, whereby the recording is created from a received broadcast signal and whereby the desired point in time is the scheduled broadcast time of the broadcast signal representing the desired part.

5. A method as claimed in claim 4, whereby an offset is obtained indicating the difference between the scheduled broadcast time and the actual point in time from which the broadcast signal representing the desired part has been received and whereby the verification whether the associated point in time substantially equals the desired point in time is based on the offset.

6. A method as claimed in claim 5, whereby the offset is obtained from an Electronic Program Guide.

7. A reproduction device enabling a user to navigate to a desired part in a recording, wherein a plurality of positions in the recording are associated with respective points in time from which the signal representing content at these positions has been received, the device comprising:
verification means for verifying whether the associated point in time of a particular one of the plurality of positions in the recording substantially equals a desired point in time from which the signal representing the desired part is known to have been received, and
proceeding means for proceeding to the particular one of the plurality of positions in the recording of which the associated point in time substantially equals the desired point in time.

8. A reproduction device as claimed in claim 7, further comprising input means for obtaining the desired point in time.

9. A reproduction device as claimed in claim 7, wherein the recording is created from a received broadcast signal and wherein the desired point in time is the scheduled broadcast time of the broadcast signal representing the desired part, the device further comprising offset obtaining means for obtaining an offset indicating the difference between the scheduled broadcast time and the actual point in time from which the broadcast signal representing the desired part has been received, and wherein the verification means is arranged to verify whether the associated point in time substantially equals the desired point in time on basis of the offset.

10. A reproduction device as claimed in claim 7, wherein the offset obtaining means is arranged to obtain the offset from an Electronic Program Guide.

11. A computer program product comprising software code for causing a processor to:
enable a user to navigate to a desired part in a recording, wherein a plurality of positions in the recording are associated with a point in time from which a signal 110 representing content at that position has been received,
verify whether the associated point in time of a particular position in the recording substantially equals a desired point in time from which the signal representing the desired part is known to have been received, and
proceed to the particular position in the recording of which the associated point in time substantially equals the desired point in time.
